(19) United States
(12) Patent Application Publication
(10) Pub. No.: US 2008/0157037 A1
(43) Pub. Date: Jul. 3, 2008

(54) Dryer seal assembly

(76) Inventors: Warren Stidham, Cohutta, GA (US); Michael Emory, Spartanburg, SC (US); John Burns, Simsonville, SC (US); David Starrett, Greer, SC (US)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6731, US

(21) Appl. No.: 11/648,364

(22) Filed: Dec. 29, 2006

(51) Int. Cl. C09K 21/00

(52) U.S. Cl. 252/609

(57) ABSTRACT

A dryer seal structure which incorporates a polyurethane foam interior. The foam incorporates a flame retardant additive of intumescent character to provide enhanced resistance to flammability.

### FIELD OF THE INVENTION

The present invention relates generally to seals for appliances, and, more particularly, to a seal for a clothes dryer including a rotatable drum. The seal incorporates a foam forming a backing or intermediate layer. The foam includes a flame retardant constituent of intumescent character.

### BACKGROUND

Automatic clothes dryers typically include a housing and a rotating drum supported within the housing. It is known to use seal elements in the form of rings of felt which may be disposed between the housing and the drum so as to bear against the drum as it rotates. The use of a sealing element is desirable to prevent air leakage between the drum and the clothes dryer cabinet which could detrimentally affect the air flow system of the dryer. It is known to utilize seals in the form of multi-layered ring structures incorporating a folded over exterior layer such as wool or wool blend nonwoven material. A spacer material such as polyester or polyester blend textile material may be held within the folded over exterior. The layers of the folded structure are typically held in place by a plurality of seams so as to establish a coordinated stable structure.

It is also known to use seal assemblies incorporating regions of enhanced thickness for use as a bearing in supporting relation to the drum. Exemplary assemblies used as bearing supports have included pliable ring structures incorporating materials such as surface pads of felt disposed at selected regions within the ring structure to dampen the vibration and noise associated with the rotation of the dryer drum. By way of example only, and not limitation, one prior assembly incorporating a support region of enhanced thickness relative to the remainder of the ring is illustrated and described in U.S. Pat. No. 6,675,496 the teachings of which are incorporated herein by reference. Another prior assembly having felt of different density disposed at different regions around a split ring bearing with a friction reducing powder coating across an upper wear surface is disclosed in U.S. Pat. No. 5,363,569 to Kadakia (incorporated by reference). Still another prior assembly is disclosed in U.S. Pat. No. 5,216,823 to Ripley (incorporated by reference) in which the bearing is comprised of a ring of felt-like material having an upper portion of relatively dense felt and a lower portion of relatively less dense felt. The upper portion includes wear-resistant pads which bear the weight of the drum.

While the prior ring seal and bearing assemblies have provided good rotational support, these construction has relied upon the joining together of several layers of fibrous material to provide the required bulk. The resultant construction may be relatively complex and require a fairly substantial amount of fiber material to form the interior layer.

### SUMMARY OF THE INVENTION

The present invention provides advantages and alternatives over the prior art by providing a seal structure which incorporates a polyurethane foam interior. The seal may be either a ring of substantially uniform thickness or a bearing structure having a region of enhanced thickness. The foam incorporates a flame retardant additive of intumescent character to provide enhanced resistance to flammability thereby allowing the foam to be substituted for the previously used fibrous interior layers. Component ratios have been identified that maintain curability of the polyurethane despite the presence of the intumescent additive thereby allowing the benefits of foam in combination with the benefits of intumescent flame retardant chemistry.

### BRIEF DESCRIPTION OF THE DRAWINGS

The present invention will now be described by way of example only, with reference to the accompanying drawings which constitute a part of the specification herein and in which:

FIG. 1 is a perspective view of an exemplary seal including a support section of enhanced thickness;

FIG. 2 is a view of the section of enhanced thickness in FIG. 1 taken along line 2-2 and

FIG. 3 is a view of the folded seamed portion taken along line 3-3 in FIG. 1.

While the invention will hereinafter be described in connection with exemplary illustrated embodiments, it is to be understood that in no event is the invention to be limited to such illustrated and described embodiments. On the contrary, it is intended that the present invention shall extend to all alternatives and modifications as may embrace the principles of this invention within the broad spirit and scope thereof.

### DESCRIPTION

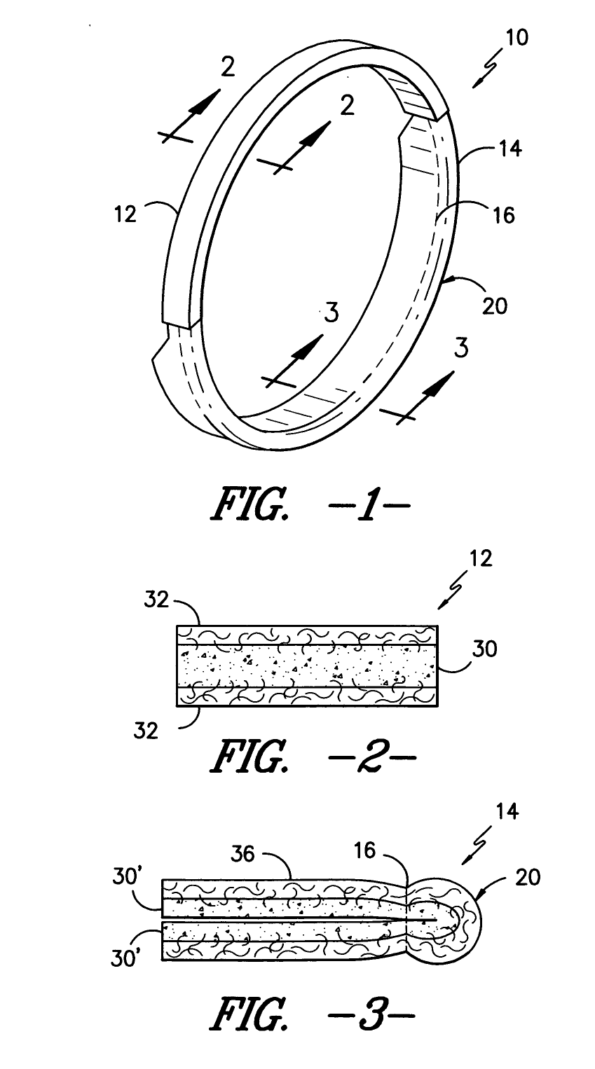

Turning now to the figures, in FIG. 1 a seal 10 is illustrated including a segment of enhanced thickness 12 which may serve as a bearing for a rotating drum (not shown). The exemplary seal 10 also includes a folded seamed section 14 including a seam 16 such as a chain stitch or the like forming a flow blocking bubble portion 20 with outwardly extending legs (FIG. 3). While the variable thickness structure as illustrated may be desirable for many applications, it is likewise contemplated that the seal may be formed entirely of the folded seamed section 14 if desired in dryers which use other load bearing members such as rollers, glide surfaces and the like. Alternatively, it is also contemplated that the seal may be formed entirely of the structure forming the load bearing segment of enhanced thickness 12 if desired.

As illustrated, the exemplary seal includes interior layers formed of foam. In particular, in the segment of enhanced thickness 12, a layer of foam 30 is disposed between layers of covering material 32 such as felt or other suitable material including woven, knit and nonwoven fabrics which provide abrasion resistance to the foam 30. The foam 30 may be cast in place across the covering material so as to be self adhering or may be secured in place by adhesives such as light weight heat activated fabric adhesives or the like. While the foam 30 is illustrated as being sandwiched between layers of covering material, the covering material may be eliminated from one side if desired. It is also contemplated that different covering materials may be used on either side of the foam 30 if desired.

As shown in FIG. 3, in the folded seamed section 14, a layer of foam 30′ is disposed across the underside of a covering material 36. The foam 30′ may be cast in place across the covering material 36 so as to be self adhering with fibers from the covering material projecting into the foam or may be secured in place by adhesives such as light weight heat activated fabric adhesives or the like. When the covering material 36 with applied foam 30′ is folded upon itself and seamed, the foam 30′ defines a resilient cushioning interior surface for the legs of the seamed structure. The covering material 36 may be felt or other suitable material including woven, knit and nonwoven fabrics which provide abrasion resistance to the foam 30′. It is contemplated that the foam 30′ may be either the same or different from the foam 30 within the segment of enhanced thickness 12. Of course, the seal is in no way limited to a particular configuration. Rather, it is contemplated that virtually any configuration adaptable for use with a foam layer may be utilized.

The foams 30, 30′ are preferably polyurethane foam compositions including a non-brominated intumescent flame retardant composition. The foams are preferably mechanically frothed substantially closed cell types thereby aiding in the blockage of air flow across the seal. However, open cell foams may also be used if desired.

As will be appreciated, polyurethane is a polymerization product of a polyol component and isocyanate component. The system may also include water. Conventional practice is to form an isocyanate mixture (mixture “A”) and a separate mixture of polyols, chain extenders, cross linking agents, fillers, blowing agents, surfactants, catalysts, etc. (mixture “B”). Mixture “A” and mixture “B” are then blended together at a desired ratio to form the polyurethane polymer. By way of example only, such procedures are disclosed in U.S. Pat. No. 5,159,012 the disclosure of which is incorporated herein by reference.

The present system departs from standard polyurethane formation practices by eliminating substantially all halogen donors. Traditional amine catalysts are also eliminated. In the absence of such amine catalysts, a nickel polyphosphate catalyst is utilized in combination with calcium carbonate, a silicone surfactant and viscosity modifier such as an ethoxylated phenol or the like. One such viscosity modifier is available under the trade designation VM3651 from Manufacturers Chemicals L.P. having a place of business in Cleveland, Tenn. The calcium carbonate is preferably present at a level of about 10% to about 40% by weight in the foam.

The polyol component may contain either a single polyol or a mixture of two or more polyols. By way of example only, and not limitation, exemplary polyols may include one or more of ethylene glycol; diethylene glycol; propylene glycol; dipropylene glycol and the like as will be well known to those of skill in the art. One potentially preferred polyol mixture is a blend of diols and triols believed to be available under the trade designation BAYEX from BayOne having a place of business in Dalton, Ga. USA.

The isocyanate component may contain either a single isocyanate or a mixture of two or more isocyanates. By way of example only and not limitation, one potentially preferred isocyanate is modified diphenylmethane 4, 4′-diisocyanate (MDI). Of course other isocyanates and polyols as will be known to those of skill in the art may also be used. Exemplary listings of such materials are set forth in U.S. Pat. No. 6,881,764 the contents of which are incorporated herein by reference. The isocyanate component is preferably utilized in stoichiometric excess to promote complete reaction with the functional groups of the polyol and with any water that may be present.

As previously noted, the polyurethane also includes a flame retardant composition. According to a potentially preferred practice, the flame retardant composition is of a so called “intumescent” character which is characterized by undergoing a swelling and charring when exposed to substantial heat. By way of example only, and not limitation, the flame retardant composition preferably contains (i) a blowing agent such as melamine, urea, dicyandiamide or combinations thereof; (ii) an acid donor such as ammonium polyphosphate, mono-ammonium phosphate, diammonium phosphate, potassium tripolyphosphate or combinations thereof; and (iii) a carbon donor such as dipentaerythritol (DPE), pentaerythritol or the like (preferably about. The blowing agent preferably makes up about 35% to about 45% of the flame retardant composition. The acid donor preferably makes up about 35% to about 45% of the flame retardant composition. The carbon donor preferably makes up about 15% to about 25% of the flame retardant composition.

By way of example only, one potentially preferred flame retardant composition is made up of about 40% melamine, about 40% ammonium polyphosphate and about 20% pentaerythritol. In one exemplary formulation This flame retardant composition is preferably used in a polyurethane blend as follows in Table 1:

TABLE 1

| | | |
|---|---|---|
| Polyol Mix | 105.8 | parts |
| MDI | 31.1 | parts |
| Flame Retardant | 125 | parts |
| Catalyst (nickel polyphosphate) | 5.8 | parts |
| Calcium Carbonate | 25.0 | |
| Silicone Surfactant | 3.0 | |
| Viscosity modifier (ethoxylated phenol) | 1.0 | |

In practice it is contemplated that the flame retardant composition may be intermixed directly with the base polyol mix. Following blending of the polyol and flame retardant composition it is contemplated that the mixture of MDI, catalyst, calcium carbonate, silicone surfactant and viscosity modifier will be added. It is also contemplated that a wide range of fillers such as ATH, clay, fly ash, glass spheres, magnesium hydroxide, carbon black and the like may also be added as desired to adjust density, resiliency or other properties.

After blending, the polyurethane composition may be frothed onto felt or other covering material adjacent to the foam in the seal and cured at a temperature of about 200 degrees F. to about 400 degrees F. By way of example only, according to one potentially preferred practice the polyurethane composition is frothed onto the felt at a thickness of about 100 to about 180 mils (preferably about 140 mils) at a coating weight mass per unit area of about 7 to 13 ounces per square yard (preferably about 10 ounces per square yard) followed by curing at about 280 degrees F. for about 7 minutes. The coated felt may then be cut into strips, folded and seamed to form the seal construction as desired

It is, of course, to be understood that while exemplary embodiments and practices have been illustrated and described, in no event is the invention to be limited to such illustrated and described embodiments and practices since modifications may be made and other embodiments of the principles of this invention will no doubt occur to those of skill in the art. Therefore, it is contemplated that the invention shall extend to all such modifications and other embodiments as may fall within the true spirit and scope of this invention.

What is claimed is:

1. A dryer seal comprising an abrasion resistant felt covering layer and at least one underlying layer of substantially halogen free polyurethane foam including an intumescent flame retardant composition.

2. The invention as recited in claim 1, wherein the polyurethane foam is a mechanically frothed substantially closed cell foam.

3. The invention as recited in claim 2, wherein the flame retardant composition comprises about 35% to about 45% ammonium polyphosphate, about 35% to about 45% melamine and about 15% to about 25% pentaerythritol.

4. The invention as recited in claim 3, wherein the polyurethane foam further comprises about 10% to about 40% by weight of calcium carbonate.

5. The invention as recited in claim 4, wherein the polyurethane foam further comprises a nickel based catalyst.

6. The invention as recited in claim 4, wherein the polyurethane foam further comprises a silicone surfactant.

7. A method of forming a dryer seal comprising the steps of:
(a) applying a layer of substantially halogen free polyurethane composition across a layer of fibrous felt wherein the polyurethane composition includes an intumescent flame retardant composition comprising a blowing agent, an acid donor and a carbon donor;
(b) curing the polyurethane at elevated temperature while in contact with the fibrous felt to form a cured foam;
(c) folding a strip of the felt with attached cured polyurethane to a desired cross sectional configuration; and
(d) applying at least one seam at least partially along the length of the folded strip to hold the desired cross sectional configuration in place

8. The invention as recited in claim 7, wherein the flame retardant composition comprises about 35% to about 45% ammonium polyphosphate, about 35% to about 45% melamine and about 15% to about 25% pentaerythritol.

9. The invention as recited in claim 8, wherein the cured foam comprises about 10% to about 40% by weight of calcium carbonate.

10. The invention as recited in claim 9, wherein the polyurethane composition further comprises a nickel polyphosphate catalyst.

11. The invention as recited in claim 10, wherein the polyurethane composition further comprises a silicone surfactant.

12. The invention as recited in claim 11, wherein the polyurethane composition further comprises an ethoxylated phenol viscosity modifier.
